(19) United States
(12) Patent Application Publication
(10) Pub. No.: US 2013/0341343 A1
(43) Pub. Date: Dec. 26, 2013

(54) MEDICATION MANAGEMENT AND ADHERENCE SYSTEM

(71) Applicant: Robert H. Lomenick, Potts Camp, MS (US)

(72) Inventor: Robert H. Lomenick, Potts Camp, MS (US)

(21) Appl. No.: 13/924,005

(22) Filed: Jun. 21, 2013

Related U.S. Application Data
(60) Provisional application No. 61/662,757, filed on Jun. 21, 2012.

(51) Int. Cl. A61J 7/04

(52) U.S. Cl. CPC A61J 7/0481
USPC 221/2

(57) ABSTRACT

We disclose herein a medication adherence system and method comprising prepackaged medication that should be taken at a preset time, and an alert system configured to remind the patient to take the medication at said time.

### FIELD OF THE INVENTION

The present invention is generally directed toward a device and system for delivery of pills and medication and ensuring that patience adhere to a schedule.

### BACKGROUND OF THE INVENTION

For many people, especially elderly patients, taking medications can be confusing due to the similarity of pills and varying frequency of administration. It can be hard for a person to remember whether they have already taken a particular pill, and whether it needed to be taken with a meal or separately from other pills.

In a setting such as a nursing home or other setting having multiple patients, this may be even more difficult to manage as the number of pills being administered can easily be confused.

Most methods to improve medication adherence are focused on changing patient behavior, such as through pill boxes or dosage simplification, or pill reminders. However, as the complexity of the combinations of medications increases, it becomes more likely that a patient will miss a medication. Occasionally, patients may try to overcome a missed prescription by doubling up on the next dose. However, this may lead to complications for the patient.

Currently, medications are synced up over a period of two to three months as the pharmacists coordinate the prescription medication such that the patient reduces visits to the pharmacy and takes all of the medication in the proper order. Proper adherence has been shown to greatly improve the patient's outcome and can reduce costs for both insurance companies and patients.

### SUMMARY OF THE INVENTION

A system for administering pills, including medications and supplements, is disclosed. The disclosed system helps ensure that the pills are taken in the proper order and at the correct time, and ensures that medication is properly synchronized.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

The disclosed system contains three primary parts—an application for synchronizing the medications, a device for packaging the medications, and a system for reminding patients that it is time to take the medications.

In one embodiment of the invention, a software application can used to synchronize the medications. The medications and supplements to be taken are inputted into the application, along with the administration instructions, such as dosage instructions and duration. The application may be configured to determine which medications can be taken together, and will group such medications such that they are taken at the same time. In a preferred embodiment, the software is linked with a pharmacy so that the pharmacy is aware of any changes that need to be made to the medication, or if a particular medication is no longer required.

Once the software determines the optimum grouping of medication, it can provide that information to a device that packages the medications together. In a preferred embodiment, the device distributes each grouping of medications into a plastic pouch that it sealed. The pouches may be connected in a serial manner such that the packaging appears as a long strip of pouches of medications. The pouches are labeled to include a time and date that the medications should be taken, along with special instructions for the patient. Because the pouches are connected together in a serial manner, the patient needs only to remember to take the medication in the first available pouch. The pouches may be disposed in a container so that only the first pouch is exposed. The patient then only needs to remove the first pouch and take the medication within it. At the time for the second medication, the second pouch in the series (which is now exposed as the first visible pouch), is removed and the medication within it is taken as directed on the label.

The third aspect of the invention is the system for reminding the patient to take the medication. The reminder may be in the form of an automated telephone call, or an alert system, such as a cell phone app. In one embodiment, a device for dispensing the pouches can be used that alerts the patient when it is time to take the medications. The device could be configured to emit a series of progressively louder beeps or lights to alert the patient, and may be further configured to only allow one pouch to be accessed at a time. Medications that are not taken at the appropriate time can be saved so that the patient can inform the doctor of certain missed medications.

At the end of a four week cycle, the patient's medication can be restocked. This may be delivered directly to the patient in the form of strips. The patient could also provide untaken pills to the pharmacist so that they may be incorporated into the pouches. Thus, the pills are not wasted.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A medication adherence system comprising:
a. a plurality of medication packages, wherein each of medication package further comprises medication to be taken together at a preset time;
b. an alert system to remind the patient to take said medication at said preset time.
